(19) United States
(12) Patent Application Publication
(10) Pub. No.: US 2026/0317210 A1
(43) Pub. Date: Oct. 15, 2026

(54) BRUSH ELECTRODES FOR LOCALLY ENHANCED ELECTRIC FIELD TREATMENT

(71) Applicant: Georgia Tech Research Corporation, Atlanta, GA (US)

(72) Inventors: Xing Xie, Atlanta, GA (US); Feiyang Mo, Atlanta, GA (US); Nian Liu, Atlanta, GA (US)

(21) Appl. No.: 19/465,305

(22) Filed: Jan. 30, 2026

Related U.S. Application Data
(60) Provisional application No. 63/751,460, filed on Jan. 30, 2025.

(51) Int. Cl. C02F 1/48

(52) U.S. Cl. CPC C02F 1/487; C02F 2303/04

(57) ABSTRACT

The present disclosure relates to water disinfection systems utilizing electric field treatment, and more particularly to brush electrodes for locally enhanced electric field treatment combining macroscale and microscale electric field enhancement for efficient microbial inactivation. A water disinfection system includes an outer electrode defining an internal cavity extending along a longitudinal axis, and a center electrode positioned within the internal cavity, including a stem and bristles extending radially outward toward the outer electrode. The system includes an inlet and outlet configured to allow fluid to enter and exit the internal cavity, and a voltage source electrically coupled to both electrodes to generate an electric field within the internal cavity.

### CROSS-REFERENCE TO RELATED APPLICATIONS

This application claims the benefit of U.S. Provisional Application No. 63/751,460, filed 30 Jan. 2025, which is hereby incorporated by reference in its entirety as if fully set forth below.

### GOVERNMENT LICENSE RIGHTS

This invention was made with government support under 2203162 awarded by the National Science Foundation. The government has certain rights in the invention.

### FIELD OF INVENTION

The present disclosure relates to water disinfection systems utilizing electric field treatment, and more particularly to brush electrodes for locally enhanced electric field treatment (LEEFT) that combine macroscale and microscale electric field enhancement for efficient microbial inactivation.

### BACKGROUND

The field of water disinfection has employed various technologies to inactivate microorganisms and render water safe for consumption and other uses. Electric field treatment (EFT) for microbial inactivation has been explored for over a century, with early approaches primarily relying on thermal effects generated by alternating current. The discovery of electroporation in the mid-twentieth century revealed that electric fields can cause non-thermal effects on cell membranes, wherein charged ions inside and outside microorganisms induce a transmembrane potential that causes lipid reorientation and pore formation in the membrane. When the electric field strength exceeds a threshold of approximately 10 kV/cm, these pores become irreversible, resulting in microbial inactivation. Conventional EFT systems typically employ high-voltage pulses in the kilovolt range applied across electrodes spaced several millimeters apart to achieve the electric field strengths required for electroporation. Such systems have found application in liquid food processing, including milk, juice, and alcoholic beverages.

However, conventional EFT systems present several limitations that have impeded broader adoption, particularly in water disinfection applications. The high voltages and short electrode spacing required to generate sufficient electric field strength result in elevated costs, high energy consumption, and potential operational risks such as electric arcs. Locally enhanced electric field treatment (LEEFT) has been developed to address these challenges by generating a non-uniform electric field that is low overall but intensified near the electrode surface, thereby reducing the required voltage. Macroscale enhancement can be achieved through specific device configurations such as coaxial electrode arrangements, while microscale enhancement can be achieved through nanowire-modified electrodes that magnify the electric field at nanowire tips based on the lightning rod effect. While microscale enhancement using nanowires can reduce operating voltages to below 10 V, the nanowires are prone to degradation and detachment from the substrate, with most nanowire-modified electrodes exhibiting lifespans of less than one week. Additionally, the complex synthesis processes required for nanowire fabrication present challenges for scaling up and mass production of LEEFT electrodes.

What is needed, therefore, is an improved electrode configuration for locally enhanced electric field treatment that provides both macroscale and microscale electric field enhancement while offering enhanced mechanical and electrochemical stability for extended operational lifespans. Such an electrode configuration would enable effective microbial inactivation at reduced operating voltages without requiring complex nanomaterial synthesis processes, thereby facilitating scalable manufacturing and broader adoption of LEEFT technology for water disinfection applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A water disinfection system can include an outer electrode defining an internal cavity extending along a longitudinal axis. The water disinfection system can include a center electrode positioned within the internal cavity and extending along at least a portion of the longitudinal axis. The center electrode can include a stem and a plurality of bristles extending radially outward from the stem toward the outer electrode. The water disinfection system can include an inlet configured to allow a fluid to enter the internal cavity. The water disinfection system can include an outlet configured to allow the fluid to exit the internal cavity. The water disinfection system can include a voltage source electrically coupled to the outer electrode and the center electrode and configured to apply a voltage across the outer electrode and the center electrode to generate an electric field within the internal cavity.

A method of disinfecting a fluid can include flowing the fluid through an internal cavity defined by an outer electrode, wherein a center electrode is positioned within the internal cavity. The center electrode can include a stem and a plurality of bristles extending radially outward from the stem toward the outer electrode. The method can include applying a voltage across the outer electrode and the center electrode to generate an electric field within the internal cavity.

An electrode assembly for a water disinfection system can include a stem extending along a longitudinal axis. The electrode assembly can include a plurality of electrically conductive bristles extending radially outward from the stem. The plurality of bristles can be configured to locally enhance an electric field at tips of the plurality of bristles when a voltage is applied to the stem. The plurality of bristles can include a material selected from the group consisting of stainless steel, titanium, copper, and carbon fiber.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a water disinfection system having an outer electrode, a center electrode with bristles, and a pulse generator, according to examples of the disclosed technology.

FIG. 2 illustrates a perspective view of a coaxial reactor configuration for water disinfection, according to examples of the disclosed technology.

FIG. 3 illustrates multiple views of a brush electrode at different scales, according to examples of the disclosed technology.

FIG. 4A illustrates a prior art electric field treatment configuration with parallel electrodes, according to examples of the disclosed technology.

FIG. 4B illustrates a cross-sectional view of a coaxial reactor configuration showing electric field distribution, according to examples of the disclosed technology.

FIG. 4C illustrates electric field distribution within a coaxial reactor configuration with bristles, according to examples of the disclosed technology.

FIG. 5 illustrates a simulation of electric field distribution within a tubular reactor with a brush electrode, according to examples of the disclosed technology.

FIG. 6 illustrates effects of different waveforms and duty cycles on inactivation efficiency, according to examples of the disclosed technology.

FIG. 7 illustrates iron concentration as a function of pulse frequency, according to examples of the disclosed technology.

FIG. 8 illustrates the relationship between frequency and log removal of bacteria, according to examples of the disclosed technology.

FIG. 9 illustrates log removal of bacteria for different numbers of reactors in series, according to examples of the disclosed technology.

FIG. 10 illustrates the relationship between voltage and log removal at different flow rates, according to examples of the disclosed technology.

FIG. 11 illustrates log removal values for different electrode configurations, according to examples of the disclosed technology.

FIG. 12 illustrates effects of methanol concentration on bacterial inactivation efficiency, according to examples of the disclosed technology.

FIG. 13 illustrates a flow cytometry analysis of an influent bacterial sample, according to examples of the disclosed technology.

FIG. 14 illustrates a flow cytometry analysis of an effluent sample, according to examples of the disclosed technology.

FIG. 15 illustrates long-term performance data for a water disinfection system with a brush electrode, according to examples of the disclosed technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to water disinfection systems and methods that utilize locally enhanced electric field treatment (LEEFT) for microbial inactivation. Conventional electric field treatment systems generate uniform electric fields between electrodes and require high voltages, often reaching several kilovolts, to achieve sufficient electric field strength for irreversible electroporation of microbial cell membranes. Such high voltage requirements result in elevated costs, high energy consumption, and potential operational risks including electric arcs.

LEEFT addresses these challenges by generating a non-uniform electric field that is low overall but intensified near electrode surfaces, thereby reducing the voltage required for effective microbial inactivation. Electric field enhancement in LEEFT systems can be achieved through two approaches. At the macroscale, specific device configurations such as coaxial electrode arrangements can amplify the electric field near a center electrode. At the microscale, electrode surface features with high aspect ratios can further magnify the electric field at tips of such features based on a lightning rod effect.

Previous LEEFT systems have utilized nanowire-modified electrodes to achieve microscale electric field enhancement. However, nanowire-modified electrodes are prone to degradation and detachment from substrate surfaces, resulting in electrode lifespans of less than one week in many cases. The synthesis of nanowire-modified electrodes also involves complex fabrication processes that limit scalability for commercial applications.

The systems and methods described herein utilize brush electrodes that combine macroscale and microscale electric field enhancement without requiring nanomaterial synthesis. A brush electrode can include a stem with a plurality of bristles extending radially outward from the stem. When positioned within a coaxial reactor configuration, the brush electrode provides macroscale enhancement through the coaxial geometry and microscale enhancement at bristle tips through the lightning rod effect. The bristles can be fabricated from mechanically robust materials such as stainless steel, which provides superior durability compared to nanowire-modified electrodes. The brush electrode configuration enables effective microbial inactivation at voltages of tens of volts rather than kilovolts, while maintaining electrode stability over extended operating periods. The brush design is customizable and scalable for commercial production using existing manufacturing processes.

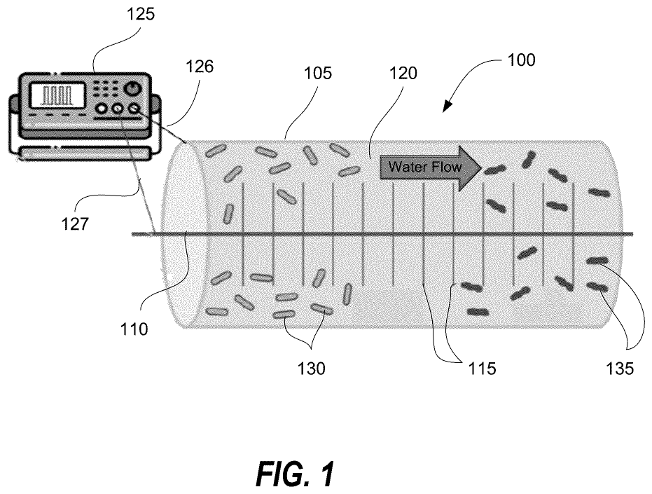

Referring to FIG. 1, a water disinfection system 100 configured for locally enhanced electric field treatment is illustrated. The water disinfection system 100 includes an outer electrode 105 that defines a chamber 120 extending along a longitudinal axis. The chamber 120 can be referred to herein as an internal cavity. The outer electrode 105 can have a cylindrical configuration, forming a tubular structure through which fluid flows during disinfection operations.

A center electrode 110 is positioned within the chamber 120 and extends along at least a portion of the longitudinal axis of the outer electrode 105. The center electrode 110 can be positioned coaxially within the outer electrode 105. The center electrode 110 includes a plurality of bristles 115 that extend radially outward from the center electrode 110 toward the outer electrode 105. The center electrode 110 can be referred to herein as a stem, with the bristles 115 radiating outward from the stem toward the inner surface of the outer electrode 105.

With continued reference to FIG. 1, the water disinfection system 100 includes an inlet positioned proximate a first end of the outer electrode 105 and configured to allow a fluid to enter the chamber 120. An outlet is positioned proximate a second end of the outer electrode 105 and configured to allow the fluid to exit the chamber 120. The water disinfection system 100 can include acrylic modules with plugs on both sides of the outer electrode 105 to secure the center electrode 110 and prevent short circuits between the outer electrode 105 and the center electrode 110.

A pulse generator 125 is electrically coupled to the outer electrode 105 and the center electrode 110. The pulse generator 125 can be referred to herein as a voltage source. A first electrical connection 126 couples the pulse generator 125 to the center electrode 110, and a second electrical connection 127 couples the pulse generator 125 to the outer electrode 105. The pulse generator 125 is configured to apply a voltage across the outer electrode 105 and the center electrode 110 to generate an electric field within the chamber 120. The voltage can be from about 50-80V in some configurations, though other voltage levels are contemplated within the scope of the present disclosure.

As further shown in FIG. 1, during operation of the water disinfection system 100, fluid containing untreated bacteria 130 (or other microorganisms) enters the chamber 120 through the inlet and flows in a direction indicated by a water flow arrow. The untreated bacteria 130 are depicted in a lower portion of the chamber 120. As the fluid passes through the chamber 120, the electric field generated between the outer electrode 105 and the center electrode 110 causes electroporation of bacterial cell membranes. The bristles 115 provide microscale electric field enhancement at tips of the bristles 115, which contributes to effective microbial inactivation. Inactivated bacteria 135 are depicted in an upper portion of the chamber 120, representing bacteria that have been treated by the enhanced electric field as the fluid flows through the water disinfection system 100.

A method of disinfecting a fluid can include flowing the fluid through the chamber 120 defined by the outer electrode 105, wherein the center electrode 110 is positioned within the chamber 120, the center electrode 110 comprising a stem and the plurality of bristles 115 extending radially outward from the stem toward the outer electrode 105. The method can further include applying a voltage across the outer electrode 105 and the center electrode 110 to generate an electric field within the chamber 120.

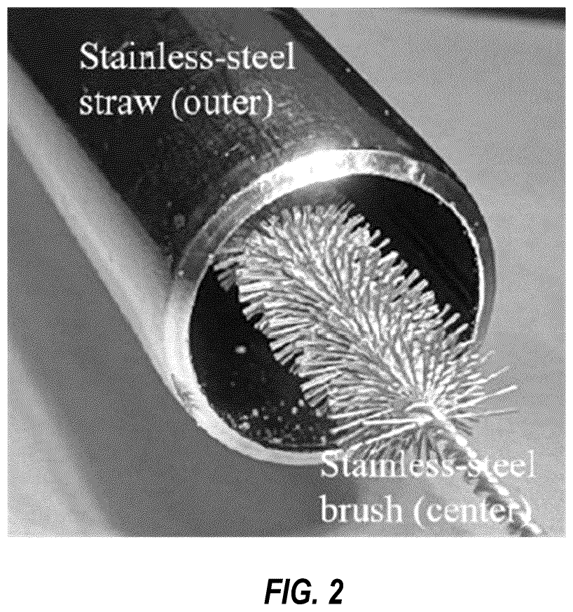

Referring to FIG. 2, a perspective view of a coaxial reactor configuration for water disinfection is illustrated. The coaxial reactor configuration includes a stainless-steel straw that serves as the outer electrode, forming a cylindrical tubular structure. A stainless-steel brush serves as the center electrode and is positioned within the stainless-steel straw. The stainless-steel brush is visible extending from an opening of the stainless-steel straw, with multiple bristles radiating outward from a central stem. The bristles are arranged to extend toward an inner surface of the outer electrode while maintaining spacing between bristle tips and the outer electrode wall. This arrangement creates a treatment cavity in an annular space between the stainless-steel brush and the outer electrode through which water can flow during disinfection operations.

With continued reference to FIG. 2, the outer electrode can have a diameter ranging from a few millimeters to allow water flow through the treatment cavity. In practical applications, the outer electrode diameter can range from a few centimeters to tens of centimeters or even a few meters for large-scale applications. The outer electrode can have a length of approximately 21.5 cm, resulting in an effective volume of approximately 10 mL for laboratory-scale demonstrations. The coaxial arrangement of the outer electrode and the center electrode with radiating bristles provides both macroscale and microscale electric field enhancement when voltage is applied across the electrodes.

The water disinfection system can be scaled for various pipeline sizes, ranging from small household pipes to large-scale water supply networks. The brush electrode design is customizable to accommodate different outer electrode diameters and lengths, allowing adaptation to specific application requirements. The scalable nature of the coaxial reactor configuration enables deployment across a range of water treatment scenarios while maintaining the dual-level electric field enhancement that enables effective microbial inactivation at reduced operating voltages compared to conventional electric field treatment systems.

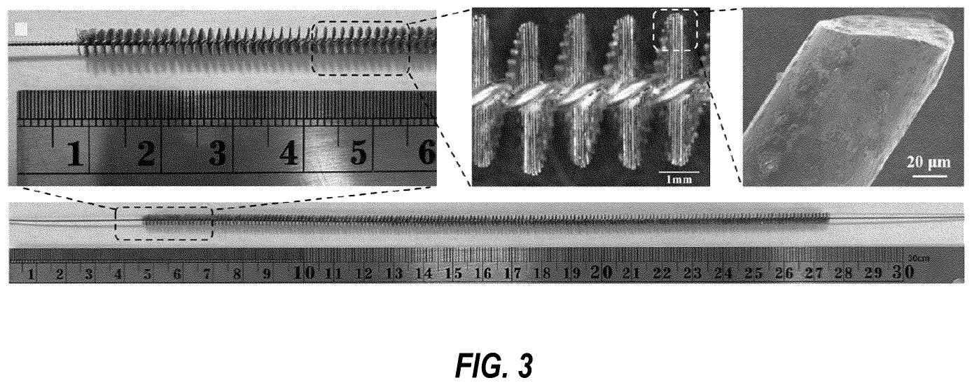

Referring to FIG. 3, multiple views of a brush electrode at different scales are illustrated. FIG. 3 includes three images arranged to show the brush electrode structure from macroscopic to microscopic detail. A rightmost image shows a full-length view of the brush electrode positioned alongside a ruler marked in centimeters, demonstrating that the brush electrode extends approximately 30 centimeters in length. The brush electrode appears as a thin elongated structure with bristles extending radially outward from a central stem.

A magnified view in a center portion of FIG. 3 shows a closer perspective of a section of the brush electrode, with a scale bar indicating 1 millimeter. This magnified view reveals the arrangement of individual bristles extending outward from the central stem in a helical or twisted pattern. The bristles appear distributed around the circumference of the central stem. An uppermost image in FIG. 3 provides a scanning electron microscope view of a single bristle tip, with a scale bar indicating 20 micrometers. This microscopic view shows the cylindrical shape and surface texture of an individual bristle, revealing a relatively smooth surface with some surface irregularities. The bristle tip appears to have a slightly rounded or blunted end.

With continued reference to FIG. 3, the stem of the center electrode can have a diameter of approximately 710 micrometers. The bristles can have a length of approximately 1.55 mm and a diameter of approximately 76 micrometers. Each bristle of the plurality of bristles can have a diameter of less than 100 micrometers. The bristles can have a high aspect ratio, with the diameter being as small as practicable while maintaining mechanical strength. In some configurations, the bristle diameter can be in the tens of micrometers range, similar to human hair diameter. Smaller bristle diameters provide greater electric field enhancement at bristle tips due to the lightning rod effect.

The plurality of bristles can have a length that is between 10% and 50% of a diameter of the outer electrode. The bristle length can be tailored to balance electric field enhancement with fluid flow considerations. Longer bristles extend closer to the outer electrode wall, resulting in stronger electric field enhancement, but longer bristles also reduce the volume available for fluid flow through the treatment cavity. The bristle length, bristle diameter, stem diameter, and outer electrode diameter can all be varied and tailored to a specific application.

The stem and the plurality of bristles can comprise a conductive material selected from the group consisting of stainless steel, carbon fiber, copper, and titanium. The conductive material can comprise stainless steel in some configurations. The center electrode can comprise 304 food-grade stainless steel, which provides mechanical and electrochemical stability suitable for water disinfection applications. The center electrode can comprise 316 stainless steel for applications requiring corrosion resistance, such as marine applications or liquid food processing, as 316 stainless steel provides corrosion resistance compared to 304 stainless steel.

The bristles can comprise graphite carbon fibers, which are more conducting than flexible carbon fibers but are also more brittle. Carbon fiber bristles can be suitable for applications where the bristles are bundled together to provide mechanical strength, though the water disinfection systems described herein benefit from separated bristles that expose individual bristle tips for electric field enhancement. Copper and titanium can also serve as conductive materials for the stem and bristles, with material selection depending on the specific application requirements including conductivity, corrosion resistance, and mechanical strength.

An electrode assembly for a water disinfection system can comprise a stem extending along a longitudinal axis and a plurality of electrically conductive bristles extending radially outward from the stem. The plurality of bristles can be configured to locally enhance an electric field at tips of the plurality of bristles when a voltage is applied to the stem. The plurality of bristles can comprise a material selected from the group consisting of stainless steel, titanium, copper, and carbon fiber.

The bristles can be spaced apart rather than densely packed to maintain the electric field enhancement effect. Dense bristle spacing can dilute the electric field enhancement effect because closely spaced bristles can interfere with the localized field concentration at individual bristle tips. The bristle spacing can be configured to allow individual bristles to function as separate field enhancement points while providing sufficient bristle density for effective treatment of fluid passing through the treatment cavity.

The center electrode can be manufactured by an external brush manufacturer using commercially available brush fabrication techniques rather than complex nanowire synthesis. The brush electrode design is compatible with existing commercial brush manufacturing processes, enabling scalable production for commercial water disinfection applications. The brush electrode configuration provides a manufacturable alternative to nanowire-modified electrodes while achieving microscale electric field enhancement through the bristle tip geometry.

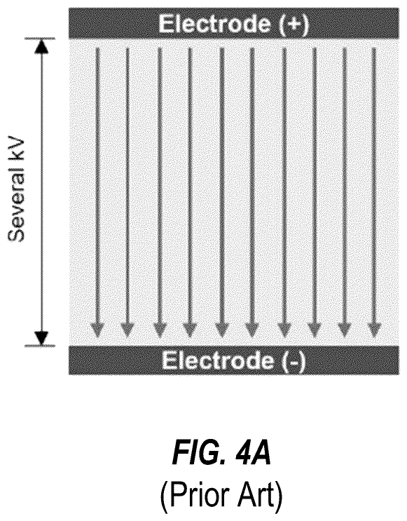

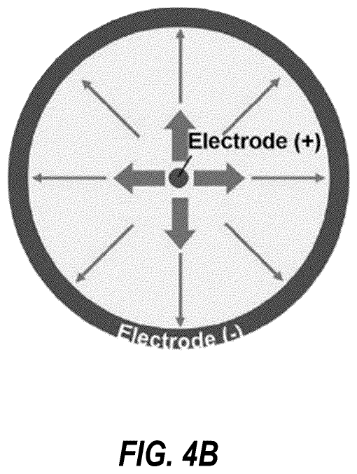

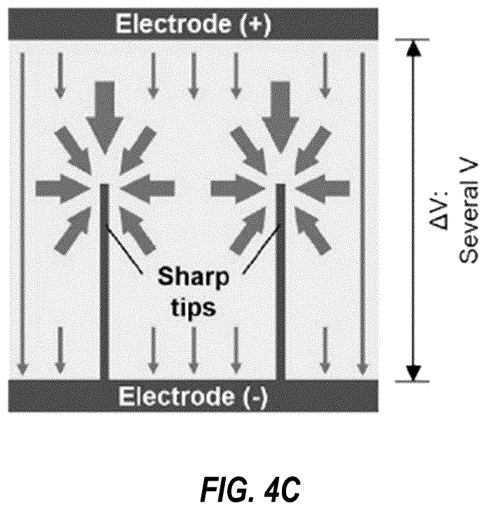

Referring to FIG. 4A, a schematic cross-sectional view of a prior art electric field treatment configuration is illustrated. A positive electrode is positioned at a top of the figure and a negative electrode is positioned at a bottom of the figure. A treatment region is disposed between the positive electrode and the negative electrode. A plurality of arrows extend from the positive electrode toward the negative electrode, indicating the direction of the electric field. The arrows are substantially parallel to one another and uniformly distributed across the treatment region, representing a uniform electric field distribution characteristic of conventional pulsed electric field treatment systems. A voltage differential of several kilovolts is indicated on a left side of the figure, representing the high voltage typically required in prior art configurations to achieve sufficient electric field strength for microbial inactivation. Conventional electric field treatment systems with parallel electrode configurations generate uniform electric fields that require high voltages to achieve the threshold electric field strength of approximately 10 kV/cm for irreversible electroporation.

Referring to FIG. 4B, a cross-sectional view of a coaxial reactor configuration illustrating the electric field distribution within a chamber is shown. A circular outer electrode forms a perimeter of the reactor, shown as a purple ring surrounding a treatment area. At a center of the reactor, a positive electrode is positioned, from which arrows extend radially outward in multiple directions. The arrows represent the direction and relative intensity of the electric field, with thicker arrows indicating regions of enhanced electric field strength near the center electrode and thinner arrows indicating weaker field strength toward the outer electrode. The electric field vectors extend in eight directions from the center electrode, including four primary directions aligned with cardinal axes and four secondary directions at diagonal orientations. A light blue region between the center electrode and the outer electrode represents the treatment chamber through which water flows during disinfection operations.

With continued reference to FIG. 4B, the coaxial electrode configuration provides macroscale electric field enhancement. The non-uniform electric field distribution characteristic of the coaxial electrode arrangement results in electric field intensity that is highest near the center electrode and decreases radially toward the outer electrode. The macroscale enhancement factor (fₘₐ) is determined by the geometry of the center and outer electrodes according to the formula:

$${f}_{ma} = \frac{D}{d} * \frac{1}{ln \frac{d}{D}}$$

where D represents the diameter of the outer electrode and d represents the diameter of the center electrode. The macroscale enhancement factor increases as the ratio of the outer electrode diameter to the center electrode diameter increases, enabling higher electric field strength near the center electrode for a given applied voltage.

Referring to FIG. 4C, a schematic cross-sectional diagram illustrating the electric field distribution within a coaxial reactor configuration for locally enhanced electric field treatment is shown. A positive electrode is positioned at a top of the diagram and a negative electrode is positioned at a bottom, with a voltage differential of several volts applied between the electrodes as indicated by notation on a right side of the figure. Two vertical structures extend upward from the negative electrode into the chamber, each structure having sharp tips at an end thereof. Green arrows throughout the diagram indicate the direction and relative intensity of the electric field, with the arrows converging toward and concentrating around the sharp tips of the vertical structures. The thickness and density of the arrows near the sharp tips demonstrate the locally enhanced electric field effect, where the electric field strength is amplified at pointed regions compared to surrounding areas.

As further shown in FIG. 4C, the sharp tips of the vertical structures provide microscale electric field enhancement based on a lightning rod effect. The microscale enhancement is proportional to the aspect ratio of the structures, with higher aspect ratios providing greater electric field amplification at the tips. The plurality of bristles locally enhance an electric field at tips of the plurality of bristles when a voltage is applied across the outer electrode and the center electrode. The combination of macroscale enhancement from the coaxial electrode geometry and microscale enhancement from the bristle tips enables the electric field near the bristle tips to reach up to 10⁶ V/m using only tens of volts. This represents a reduction from the several kilovolts typically required in conventional electric field treatment systems with parallel electrode configurations, as illustrated in FIG. 4A.

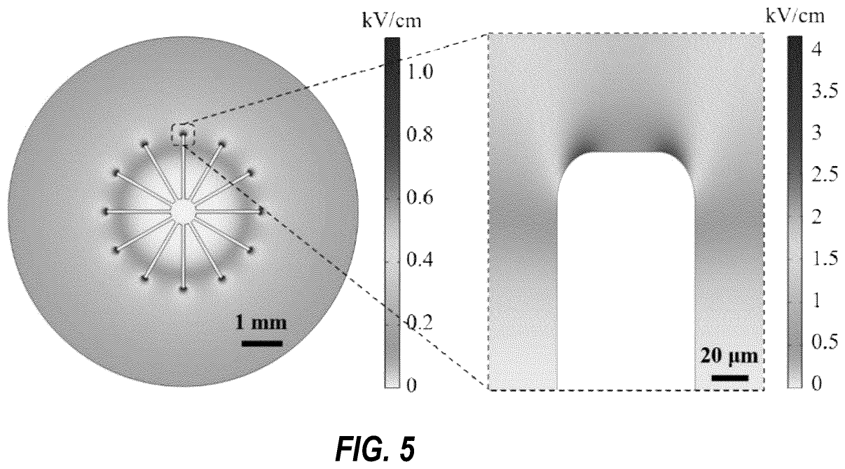

Referring to FIG. 5, a COMSOL simulation of the electric field distribution within a tubular reactor with coaxial electrodes featuring a brush electrode as the center electrode is illustrated. A left portion of FIG. 5 shows a circular cross-sectional view of the reactor with a scale bar indicating 1 mm. The electric field strength is represented by a color gradient ranging from 0 to 1.0 kV/cm. The simulation reveals that the electric field is strongest near bristle tips extending radially from the center electrode, as indicated by red and orange coloring at approximately 0.8 to 1.0 kV/cm. The electric field gradually decreases toward the outer electrode, transitioning through yellow, green, and blue regions representing progressively lower field strengths approaching 0 kV/cm.

A right portion of FIG. 5 shows a magnified view of a single bristle tip region with a scale bar indicating 20 μm. The electric field strength in the magnified view is represented by a separate color gradient ranging from 0 to 4 kV/cm. This magnified view demonstrates the lightning rod effect at the bristle tip, where the local electric field reaches approximately 3.5 to 4 kV/cm at the sharp tip of the bristle, as shown by red coloring. The electric field rapidly decreases with distance from the tip through orange, yellow, green, and blue regions. Dashed lines connecting the two views indicate the correspondence between the magnified region and the location of the magnified region in the full cross-sectional view.

With continued reference to FIG. 5, the simulation illustrates the dual-level enhancement achieved by the brush electrode configuration. The macroscale enhancement results from the coaxial configuration, where the electric field is concentrated near the center electrode due to the radial geometry. The microscale enhancement results from the bristle tips, where the lightning rod effect causes exponential amplification of the electric field at the pointed bristle ends. The combination of these two enhancement mechanisms enables the local electric field at the bristle tips to reach values sufficient for irreversible electroporation while the applied voltage remains in the range of tens of volts.

The COMSOL simulation was conducted two-dimensionally to demonstrate local enhancement effects. Practical electric fields in experimental conditions can differ due to three-dimensional complexities in the reactor geometry and fluid flow patterns. The simulation results indicate that the brush electrode configuration provides regionally intensified electric field conditions conducive to electroporation of microbial cell membranes passing near the bristle tips during fluid flow through the treatment cavity.

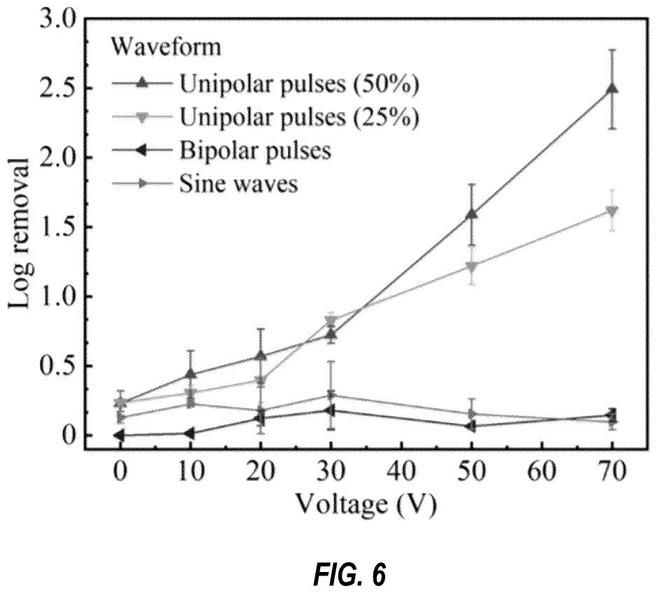

Referring to FIG. 6, a graph illustrating the effects of different waveforms and duty cycles on inactivation efficiency as a function of voltage is shown. The vertical axis represents log removal, ranging from 0 to 3.0, while the horizontal axis represents voltage in volts, ranging from 0 to 70 V. Four different waveform conditions are plotted: unipolar pulses with a 50% duty cycle, unipolar pulses with a 25% duty cycle, bipolar pulses, and sine waves.

As shown in FIG. 6, unipolar pulses with a 50% duty cycle achieve the highest log removal values, reaching approximately 2.5 log removal at 70 V. Unipolar pulses with a 25% duty cycle show intermediate performance, achieving approximately 1.6 log removal at 70 V. Both bipolar pulses and sine waves exhibit minimal inactivation efficiency across the entire voltage range tested, with log removal values remaining below approximately 0.3 even at 70 V. The data points demonstrate that inactivation efficiency increases with increasing voltage for the unipolar pulse conditions.

With continued reference to FIG. 6, the voltage source can be configured to apply unipolar pulses across the outer electrode and the center electrode. The pulse generator can be configured to apply unipolar pulses with a 50% duty cycle for inactivation efficiency. The unipolar pulses can have a duty cycle of at least 25%. In the water disinfection system, the voltage source configured to apply unipolar pulses provides continuous charging of the electrode surface, which allows reactive oxygen species generation that promotes bacterial inactivation. Additionally, unipolar pulses facilitate bacterial transport toward the center electrode, as negatively charged bacteria are attracted to the center electrode when positive pulses are applied.

The inefficacy of bipolar pulses and sine waves can be attributed to two factors. First, the rapid switching of voltage direction in bipolar waveforms prevents charge accumulation on the electrode surface, eliminating electrochemical reactions that contribute to microbial inactivation. Second, bacterial transport is impaired under bipolar waveforms because the alternating voltage causes bacteria to oscillate back and forth, preventing bacteria from reaching the bristle tips where the electric field is locally enhanced. Under bipolar waveforms, bacteria initially near the center electrode can be inactivated, while bacteria in regions with weaker electric fields remain unaffected.

A method of disinfecting a fluid can include applying a voltage across the outer electrode and the center electrode, wherein applying the voltage comprises applying unipolar pulses across the outer electrode and the center electrode. The unipolar pulses can have a duty cycle of at least 25%. Higher duty cycles provide longer effective treatment time within each pulse cycle, facilitating electroporation of microbial cell membranes. With a fixed pulse width, a 25% duty cycle results in double the rest time between pulses compared to a 50% duty cycle, allowing electrons on the electrode to discharge and thereby reducing reactive oxygen species generation. In applications involving water with higher conductivity, employing lower-duty-cycle pulses can help minimize electrode corrosion and water splitting while still achieving effective microbial inactivation.

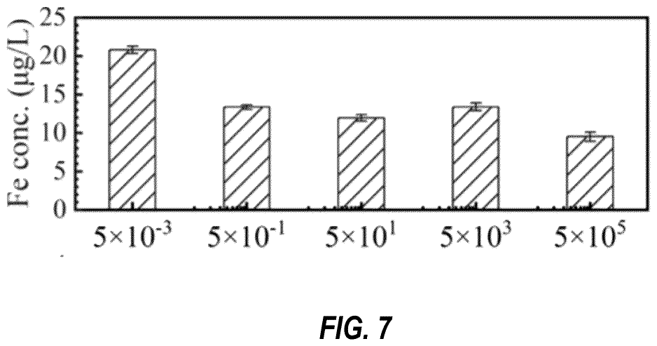

Referring to FIG. 7, a bar graph illustrating iron (Fe) concentration in micrograms per liter as a function of pulse frequency is shown. The vertical axis represents Fe concentration ranging from 0 to 25 μg/L, while the horizontal axis displays five different frequency values. The Fe concentration is highest at the lowest frequency, measuring approximately 20 μg/L, and generally decreases as frequency increases. At the highest frequency tested, the concentration decreases to approximately 9 μg/L. The data demonstrates that metal release from the electrode decreases with increasing pulse frequency during operation of the water disinfection system.

With continued reference to FIG. 7, the water disinfection system releases iron concentrations below 25 micrograms per liter during operation. Chromium concentrations remain below 4 micrograms per liter, and nickel concentrations remain below 1 microgram per liter. Such low metal release concentrations can be attributed to the electrochemical stability of stainless steel, which results from a native passive layer formed on the stainless steel surface. The low level of metal release is suitable for drinking water disinfection applications. The decline in metal release with increasing frequency can be attributed to shorter pulse widths at higher frequencies under the same duty cycle. Given that electrochemical reactions typically occur on microsecond timescales, shorter pulse widths do not allow sufficient time for metal release reactions to proceed to completion.

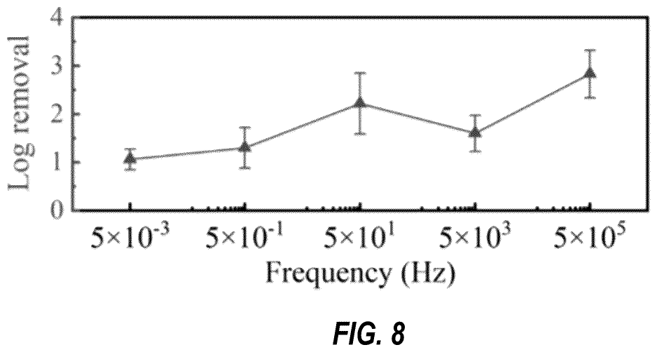

Referring to FIG. 8, a graph illustrating the relationship between frequency and log removal of bacteria in a water disinfection system is shown. The horizontal axis represents frequency measured in Hertz, spanning from 5×10⁻³ Hz to 5×10⁵ Hz on a logarithmic scale. The vertical axis represents log removal, ranging from 0 to 4. The graph shows that log removal increases from approximately 1 at the lowest frequency to approximately 2.8 at the highest tested frequency of 5×10⁵ Hz. The data demonstrates that higher frequencies generally correlate with improved inactivation efficiency.

As further shown in FIG. 8, the pulse generator can be configured to apply pulses at frequencies ranging from 50 Hz to 5 MHz, with higher frequencies generally improving inactivation efficiency. The trend toward improved inactivation at higher frequencies can be attributed to two factors. First, higher frequencies deliver more pulses within the same treatment time, which can lead to bacterial membrane fatigue and enhanced inactivation. Second, higher frequencies can allow more current to pass through bacteria cells. Since bacterial membranes behave like capacitors, as frequency increases, capacitive reactance decreases, lowering cell impedance and contributing to inactivation.

The pulse generator can be configured to apply pulses at a frequency of 500 kHz for disinfection performance with minimal metal release. In a method of disinfecting a fluid, the unipolar pulses can have a frequency of at least 500 kHz. At this frequency, the water disinfection system achieves effective log removal while maintaining low metal release levels suitable for drinking water applications. The combination of high-frequency unipolar pulses with the brush electrode configuration enables effective microbial inactivation at reduced operating voltages while minimizing electrode corrosion and metal contamination of treated water.

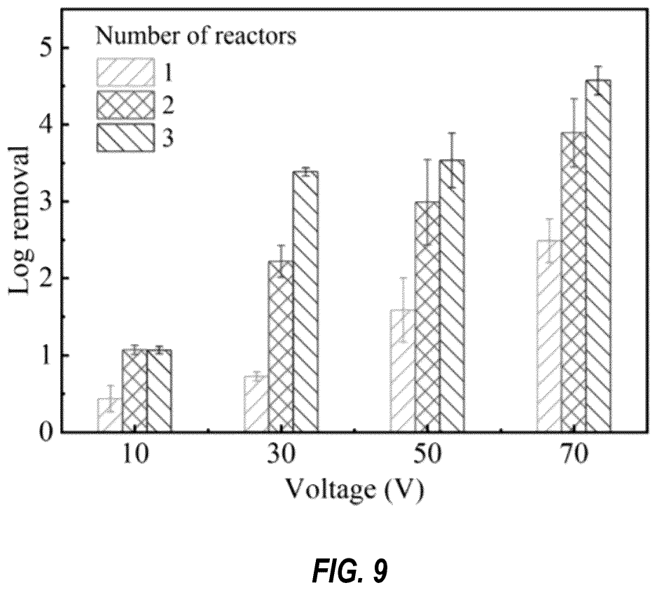

Referring to FIG. 9, a bar graph illustrating the relationship between voltage and log removal of bacteria for different numbers of reactors in series is shown. The horizontal axis represents voltage measured in volts, with values of 10, 30, 50, and 70 volts shown. The vertical axis represents log removal, ranging from 0 to 5. Three different configurations are compared, corresponding to one reactor, two reactors, and three reactors connected in series.

As shown in FIG. 9, log removal increases with both higher voltage and greater number of reactors in series. At 10 volts, all three configurations achieve relatively low log removal values below approximately 1.1 log. At 30 volts, a single reactor achieves approximately 0.7 log removal, two reactors achieve approximately 2.2 log removal, and three reactors achieve approximately 3.4 log removal. At 50 volts, a single reactor achieves approximately 1.5 log removal, two reactors achieve approximately 3.0 log removal, and three reactors achieve approximately 3.5 log removal. At 70 volts, a single reactor achieves approximately 2.5 log removal, two reactors achieve approximately 3.9 log removal, and three reactors achieve approximately 4.6 log removal.

With continued reference to FIG. 9, multiple water disinfection systems can be connected in series to improve inactivation efficiency. The incremental gain in log removal decreases with additional reactors in series. This reduction can be attributed to sample remixing between reactors and the buildup of inactivated bacteria after each stage, which can partially impede live bacteria from reaching the center electrode for effective inactivation. Given that two reactors achieve approximately 3.9-log removal at 70 V, and an additional reactor contributes less than 1-log improvement in inactivation, a configuration with two reactors in series can provide effective disinfection performance while balancing system complexity and cost considerations.

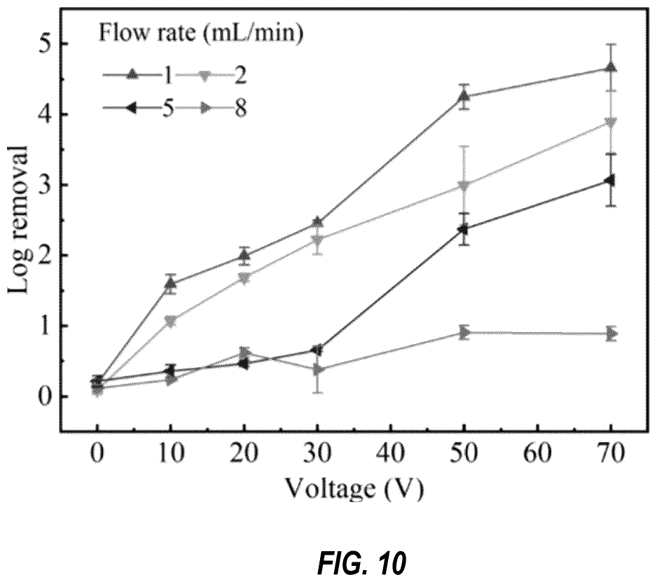

Referring to FIG. 10, a graph illustrating the relationship between voltage and log removal of bacteria at different flow rates for a water disinfection system is shown. The horizontal axis represents voltage measured in volts, ranging from 0 to 70 volts. The vertical axis represents log removal, ranging from 0 to 5. Four different flow rates are shown, corresponding to 1 mL/min, 2 mL/min, 5 mL/min, and 8 mL/min, each represented by a distinct line with data points and error bars.

As shown in FIG. 10, log removal increases with increasing voltage for all flow rates tested. Lower flow rates achieve higher log removal values at equivalent voltages. At 70 volts, the 1 mL/min flow rate achieves approximately 4.7 log removal, while the 8 mL/min flow rate achieves less than 1 log removal at the same voltage. The 2 mL/min flow rate reaches approximately 3.9 log removal at 70 volts, and the 5 mL/min flow rate reaches approximately 3 log removal at 70 volts. At lower voltages below 30 volts, the higher flow rates of 5 mL/min and 8 mL/min show minimal log removal compared to the lower flow rates of 1 mL/min and 2 mL/min.

With continued reference to FIG. 10, the water disinfection system can operate at flow rates ranging from 1 mL/min to 8 mL/min. Lower flow rates provide higher inactivation efficiency due to increased hydraulic retention time within the treatment cavity. A lower flow rate increases the time that fluid remains within the chamber, facilitating electroporation of bacterial cell membranes. Additionally, longer hydraulic retention time allows more bacteria to be drawn toward the center electrode, particularly toward bristle tips where the electric field is locally enhanced, resulting in higher inactivation efficiency.

The water disinfection system can operate at a flow rate of approximately 2 mL/min for inactivation efficiency. At this flow rate, the water disinfection system achieves approximately 3.9 log removal at 70 volts with two reactors in series, providing effective disinfection performance while maintaining reasonable throughput. At the higher flow rate of 8 mL/min, the inactivation efficiency remains below 1 log even at 70 V because bacteria are flushed out of the reactor before reaching the bristle tips where the locally enhanced electric field causes electroporation. The flow rate can be selected based on the specific application requirements, balancing inactivation efficiency against throughput considerations.

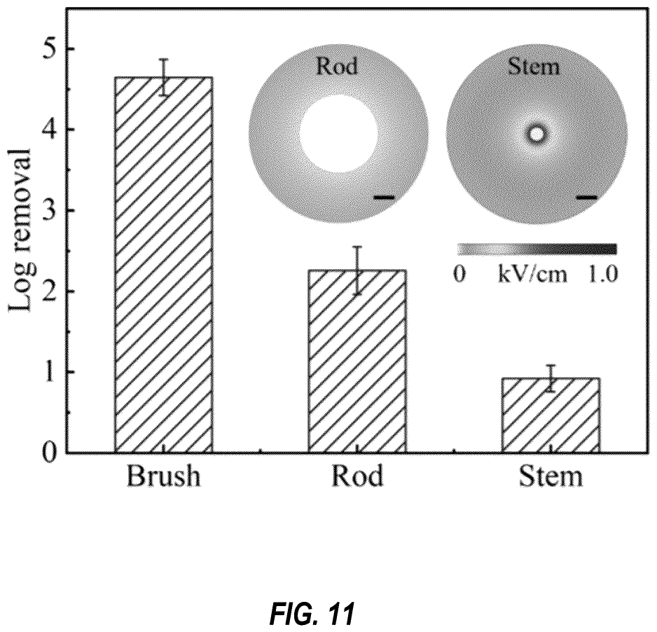

Referring to FIG. 11, a bar graph comparing log removal values for three different electrode configurations is shown. The vertical axis represents log removal on a scale from 0 to 5, while the horizontal axis displays the three electrode types: Brush, Rod, and Stem. The Brush electrode configuration achieves the highest log removal value of approximately 4.6, followed by the Rod electrode configuration at approximately 2.3, and the Stem electrode configuration at approximately 0.9. Two inset images are positioned above the Rod and Stem bars, showing cross-sectional COMSOL simulations of electric field distribution within the tubular reactor for each electrode type.

As shown in FIG. 11, the brush electrode configuration achieves approximately 2.3-log higher inactivation efficiency compared to the rod electrode configuration. The rod electrode has a similar diameter to the brush electrode, resulting in a comparable electric field distribution at the macroscale. The difference in inactivation efficiency between the brush electrode and the rod electrode can be attributed to the microscale electric field enhancement induced by the bristle tips on the brush electrode. The bristle tips provide localized electric field amplification through the lightning rod effect, which is absent in the rod electrode configuration that presents a smooth cylindrical surface without protruding features.

With continued reference to FIG. 11, the stem electrode configuration achieves the lowest log removal value of approximately 0.9. The stem electrode represents the central wire of the brush electrode without the radiating bristles. The reduced inactivation efficiency of the stem electrode compared to both the brush electrode and the rod electrode demonstrates the contribution of electrode surface geometry to electric field enhancement and microbial inactivation. The stem electrode provides macroscale enhancement from the coaxial geometry but lacks both the increased surface area of the rod electrode and the microscale enhancement from bristle tips present in the brush electrode.

The COMSOL simulation insets in FIG. 11 illustrate the electric field distribution for the rod and stem electrode configurations. The Rod inset displays a circular cross-section with a hollow center representing the rod electrode, with electric field intensity indicated by color gradation from the center outward. The Stem inset shows a similar circular cross-section with a smaller central point representing the stem electrode, with concentrated electric field intensity near the center. A color scale bar ranging from 0 to 1.0 kV/cm indicates electric field strength in the simulation images. The simulations demonstrate that while both the rod and stem configurations provide macroscale enhancement from the coaxial geometry, neither configuration achieves the localized field intensification at discrete points that characterizes the brush electrode with its protruding bristle tips.

The comparison of electrode configurations demonstrates that the combination of macroscale enhancement from the coaxial geometry and microscale enhancement from the bristle tips enables the brush electrode to achieve effective microbial inactivation at reduced operating voltages. The brush electrode configuration provides approximately 3.7-log higher inactivation efficiency compared to the stem electrode and approximately 2.3-log higher inactivation efficiency compared to the rod electrode under equivalent operating conditions. The microscale enhancement from the bristle tips contributes to the inactivation mechanism by creating regions of intensified electric field strength sufficient for irreversible electroporation of bacterial cell membranes passing near the bristle tips during fluid flow through the treatment cavity.

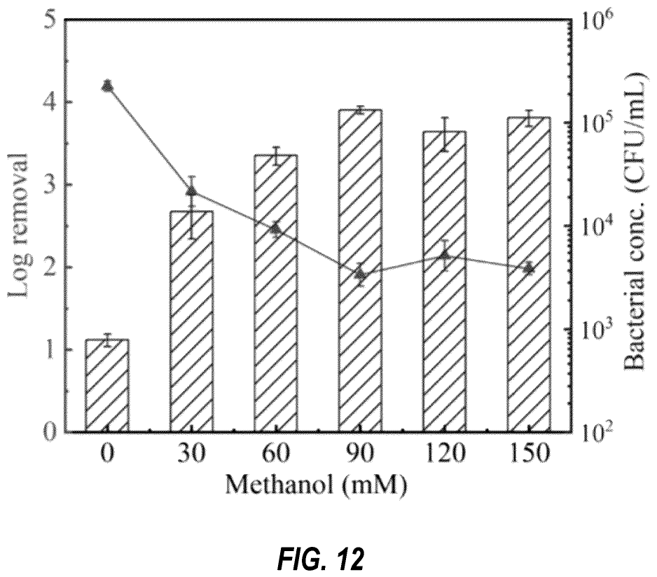

Referring to FIG. 12, a graph illustrating the effects of methanol concentration on bacterial inactivation efficiency and bacterial concentration in a locally enhanced electric field treatment system is shown. The horizontal axis represents methanol concentration in millimolar units, ranging from 0 to 150 mM. The left vertical axis represents log removal values, ranging from 0 to 5, while the right vertical axis represents bacterial concentration in colony-forming units per milliliter on a logarithmic scale, ranging from 10² to 10⁶ CFU/mL. Hatched bars indicate log removal values at each methanol concentration tested, and a line with triangular markers represents bacterial concentration.

As shown in FIG. 12, the inactivation efficiency varies with methanol concentration. At 0 mM methanol, the log removal is approximately 1.1. The log removal increases to approximately 2.7 at 30 mM methanol, approximately 3.4 at 60 mM methanol, and reaches approximately 3.9 at 90 mM methanol. The log removal then slightly decreases to approximately 3.6 at 120 mM methanol before returning to approximately 3.9 at 150 mM methanol. The bacterial concentration decreases from approximately 1.5×10⁵ CFU/mL at 0 mM methanol to approximately 8×10³ CFU/mL at 90 mM methanol, then remains relatively stable at higher methanol concentrations.

With continued reference to FIG. 12, methanol serves as a reactive species inhibitor in the water disinfection system. The variation in inactivation efficiency with methanol concentration demonstrates the role of reactive oxygen species (ROS) in the inactivation mechanism. The inactivation mechanism involves electroporation assisted by reactive oxygen species generated at the electrode surface. When unipolar pulses are applied to the center electrode, continuous charging of the electrode surface allows ROS generation, which promotes bacterial inactivation in combination with electroporation caused by the locally enhanced electric field at the bristle tips. The synergistic effects between electroporation and ROS contribute to the overall microbial inactivation achieved by the water disinfection system.

The water disinfection system can further comprise a non-conductive material disposed in an area between adjacent bristles of at least a portion of the plurality of bristles. The non-conductive material can be configured to inhibit the flow of water in the area. The non-conductive material disposed between adjacent bristles can comprise resin or other insulating polymers to block water flow through the center area while exposing the bristle tips. The non-conductive material fills the space between bristles up to but not covering the tips of the bristles, ensuring the bristle tips remain exposed for electric field enhancement.

The non-conductive material serves multiple purposes in the water disinfection system. First, the non-conductive material can provide structural support for the bristles, helping to hold the bristle structure in place during operation. Second, the non-conductive material blocks water from flowing through the center portion of the treatment cavity where the electric field strength is relatively low. The center area between the bristles represents a region where the electric field is not sufficiently enhanced for effective microbial inactivation. By filling this center area with the non-conductive material, water is directed to flow through the outer annular region where the bristle tips are exposed and where the locally enhanced electric field causes electroporation of bacterial cell membranes. Third, the non-conductive material prevents water from stagnating in dead zones between the bristles, which can affect treatment performance by allowing untreated bacteria to accumulate in regions with insufficient electric field strength.

The non-conductive material can comprise resin, polymer, or other insulating materials that do not conduct electricity. The non-conductive material does not interfere with the electric field distribution at the bristle tips because the bristle tips remain exposed above the surface of the non-conductive material. The non-conductive material can be applied to the center electrode after fabrication of the brush electrode, filling the spaces between adjacent bristles while leaving the bristle tips protruding from the non-conductive material surface. The exposed bristle tips continue to provide microscale electric field enhancement through the lightning rod effect when voltage is applied across the outer electrode and the center electrode.

The pulse generator can apply lower-duty-cycle pulses when treating water with higher conductivity to minimize electrode corrosion and water splitting. In practical applications, drinking water conductivity is often higher than the deionized water used in laboratory demonstrations. Higher conductivity increases the current flowing through the water disinfection system, which leads to more intense electrochemical reactions and can cause undesirable effects including electrode corrosion and ohmic heating. By employing lower-duty-cycle pulses, the water disinfection system can reduce the time during which electrochemical reactions occur at the electrode surface, thereby minimizing metal release and extending electrode lifespan while still achieving effective microbial inactivation. The duty cycle can be adjusted based on the conductivity of the water being treated to balance inactivation efficiency against electrode durability and metal release considerations.

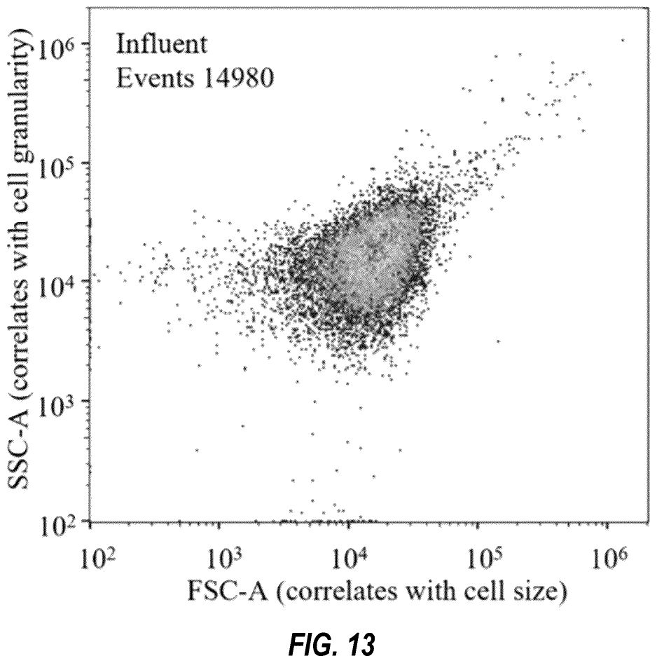

Referring to FIG. 13, a flow cytometry dot plot showing the analysis of influent bacterial samples is illustrated. The horizontal axis represents FSC-A, which correlates with cell size, displayed on a logarithmic scale ranging from 10² to 10⁶. The vertical axis represents SSC-A, which correlates with cell granularity, also displayed on a logarithmic scale ranging from 10² to 10⁶. The plot contains 14,980 events as indicated in an upper left portion of the figure. The data points form a primary population cluster centered approximately between 10³ and 10⁵ on both axes, with the highest density region shown in red and orange colors transitioning to yellow, green, and blue as the density decreases. Scattered data points extend from the main population toward higher FSC-A and SSC-A values, indicating the presence of cells with varying sizes and granularities in the influent sample prior to treatment.

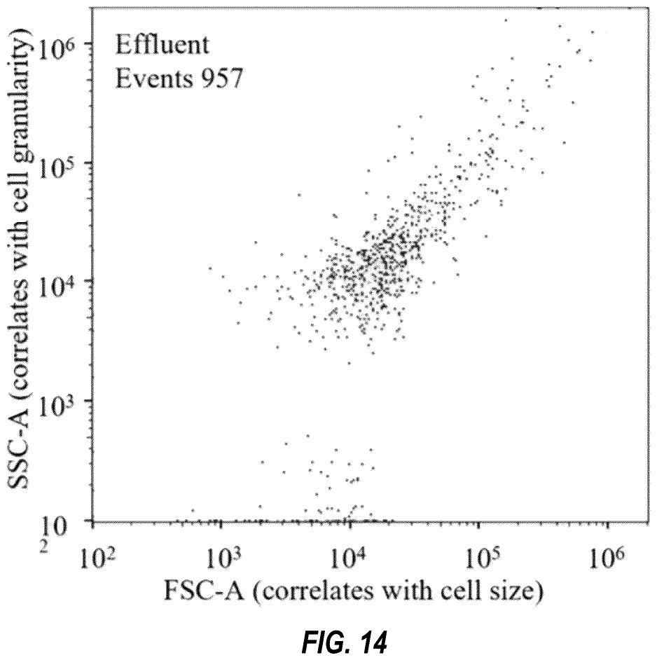

Referring to FIG. 14, a flow cytometry dot plot showing the effluent sample from a locally enhanced electric field treatment system is illustrated. The horizontal axis represents FSC-A displayed on a logarithmic scale ranging from 10² to 10⁶, and the vertical axis represents SSC-A also displayed on a logarithmic scale ranging from 10² to 10⁶. The plot is labeled as “Effluent” with 957 events detected, representing a reduction from the 14,980 events detected in the influent sample shown in FIG. 13. The data points are distributed in two regions: a main population cluster extending diagonally from approximately 10⁴ to 10⁶ on both axes, and a secondary population along a lower boundary of the plot near the 10² SSC-A level spanning from approximately 10³ to 10⁵ on the FSC-A axis.

With continued reference to FIG. 13 and FIG. 14, the reduction in bacterial events from 14,980 in the influent to 957 in the effluent represents approximately 1.2-log reduction in detected bacterial events. This reduction can be attributed to electrosorption of bacteria onto the electrode surface or cell lysis caused by the locally enhanced electric field treatment. The flow cytometry analysis demonstrates that a portion of the bacterial removal achieved by the water disinfection system results from physical removal of bacteria from the fluid stream rather than inactivation alone. However, the standard plate count method indicates over 4-log removal of viable bacteria, which exceeds the 1.2-log reduction in bacterial events detected by flow cytometry. The difference between the flow cytometry results and the plate count results indicates that the majority of inactivation efficiency results from electroporation and reactive oxygen species rather than electrosorption or physical removal of bacteria from the fluid.

The flow cytometry analysis can be performed by collecting influent and effluent samples and staining the samples with fluorescent dyes such as SYTOX Green and propidium iodide. After staining, the samples can be incubated in the dark at room temperature and analyzed using a flow cytometer. An FSC-A threshold can be set to eliminate the effects of background noise from the analysis. The flow cytometry results provide information about the number of bacterial events in the influent and effluent samples, as well as information about cell membrane integrity based on dye uptake. The combination of flow cytometry analysis with standard plate count methods provides a comprehensive assessment of the inactivation mechanisms operating within the water disinfection system, distinguishing between bacterial removal through electrosorption and bacterial inactivation through electroporation and reactive oxygen species.

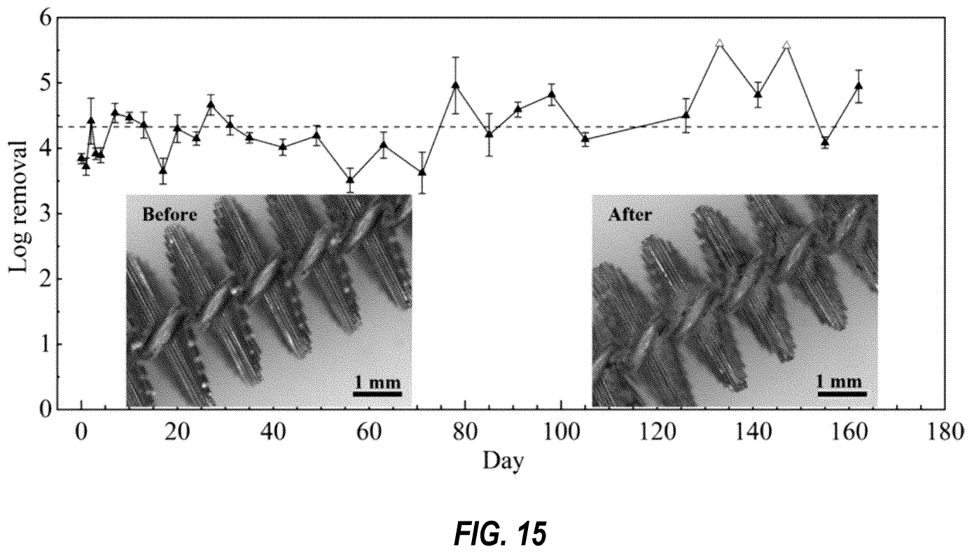

Referring to FIG. 15, a graph showing long-term performance data for a locally enhanced electric field treatment system with a brush electrode for bacteria inactivation is illustrated. The horizontal axis represents time measured in days, spanning from 0 to approximately 180 days. The vertical axis represents log removal, ranging from 0 to 6. A data series with error bars shows the inactivation efficiency over the duration of the long-term test, with values fluctuating around a horizontal dashed line indicating an average value of approximately 4-log removal. The data points demonstrate that the water disinfection system maintained stable inactivation performance throughout the approximately six-month testing period.

As further shown in FIG. 15, an inset within the graph displays two microscope images of the brush electrode, labeled “Before” and “After,” each with a scale bar indicating 1 mm. The “Before” image shows the brush electrode prior to operation, while the “After” image shows the brush electrode following the long-term test. The “After” image reveals visible changes to the electrode surface including evidence of rusting and corrosion, particularly at junctions between the bristles and the central stem. Despite these visible changes, the brush electrode maintained effective inactivation performance throughout the testing period.

With continued reference to FIG. 15, the water disinfection system can achieve 4-log inactivation efficiency for over one month of continuous operation with minimal electrode corrosion. The iron release during long-term operation ranged from 13 to 22 μg/L, while chromium levels remained below 10 μg/L and nickel levels remained below 1 μg/L. These metal release levels remained consistent with those measured during initial testing of fresh-prepared devices, indicating that electrode corrosion did not substantially increase over the extended operating period.

The water disinfection system can achieve approximately half a year of stable operation, representing a 10-fold increase in lifespan compared to previous LEEFT configurations. Previous LEEFT electrodes utilizing nanowire-modified surfaces demonstrated lifespans of less than one week in many cases, with the most stable previous configuration lasting approximately 15 days of continuous operation. The brush electrode configuration extends the operational lifespan to over one month of continuous operation, with the data in FIG. 15 demonstrating stable performance over approximately 180 days. The extended lifespan results from the mechanical and electrochemical stability of the stainless steel bristles compared to nanowire structures that are prone to degradation and detachment from substrate surfaces.

The water disinfection system can be used for treating non-potable water in swimming pools, hot water lines, and liquid food processing systems. In swimming pool applications, the water disinfection system can provide chlorine-free disinfection that avoids the formation of disinfection byproducts associated with chlorine treatment. In hot water line applications, the water disinfection system can provide point-of-use disinfection to control microbial growth in building water systems. In liquid food processing applications, the water disinfection system can provide non-thermal disinfection that preserves food quality while achieving effective microbial inactivation. The brush electrode configuration enables deployment across these various applications due to the scalable design that can be adapted to different pipeline sizes and flow rate requirements.

The disclosed technology can be further understood according to the following clauses:

Clause 1: A water disinfection system, comprising: an outer electrode defining an internal cavity extending along a longitudinal axis; a center electrode positioned within the internal cavity and extending along at least a portion of the longitudinal axis, the center electrode comprising a stem and a plurality of bristles extending radially outward from the stem toward the outer electrode; an inlet configured to allow a fluid to enter the internal cavity; an outlet configured to allow the fluid to exit the internal cavity; and a voltage source electrically coupled to the outer electrode and the center electrode and configured to apply a voltage across the outer electrode and the center electrode to generate an electric field within the internal cavity.

Clause 2: The water disinfection system of clause 1, wherein the outer electrode has a cylindrical configuration.

Clause 3: The water disinfection system of clause 2, wherein the center electrode is positioned coaxially within the outer electrode.

Clause 4: The water disinfection system of clause 1, wherein the stem and the plurality of bristles comprise a conductive material selected from the group consisting of stainless steel, carbon fiber, copper, and titanium.

Clause 5: The water disinfection system of clause 4, wherein the conductive material comprises stainless steel.

Clause 6: The water disinfection system of clause 1, wherein the voltage source is configured to apply unipolar pulses across the outer electrode and the center electrode.

Clause 7: The water disinfection system of clause 6, wherein the unipolar pulses have a duty cycle of at least 25%.

Clause 8: The water disinfection system of clause 1, further comprising a non-conductive material disposed in an area between adjacent bristles of at least a portion of the plurality of bristles, the non-conductive material configured to inhibit the flow of water in the area.

Clause 9: The water disinfection system of clause 1, wherein the plurality of bristles have a length that is between 10% and 50% of a diameter of the outer electrode.

Clause 10: The water disinfection system of clause 1, wherein each bristle of the plurality of bristles has a diameter of less than 100 micrometers.

Clause 11: The water disinfection system of clause 1, wherein the voltage is from about 50-80V.

Clause 12: A method of disinfecting a fluid, comprising: flowing the fluid through an internal cavity defined by an outer electrode, wherein a center electrode is positioned within the internal cavity, the center electrode comprising a stem and a plurality of bristles extending radially outward from the stem toward the outer electrode; and applying a voltage across the outer electrode and the center electrode to generate an electric field within the internal cavity.

Clause 13: The method of clause 12, wherein applying the voltage comprises applying unipolar pulses across the outer electrode and the center electrode.

Clause 14: The method of clause 13, wherein the unipolar pulses have a duty cycle of at least 25%.

Clause 15: The method of clause 14, wherein the unipolar pulses have a frequency of at least 500 kHz.

Clause 16: The method of clause 12, wherein the plurality of bristles locally enhance an electric field at tips of the plurality of bristles when the voltage is applied across the outer electrode and the center electrode.

Clause 17: An electrode assembly for a water disinfection system, comprising: a stem extending along a longitudinal axis; and a plurality of electrically conductive bristles extending radially outward from the stem, wherein the plurality of bristles are configured to locally enhance an electric field at tips of the plurality of bristles when a voltage is applied to the stem, and wherein the plurality of bristles comprise a material selected from the group consisting of stainless steel, titanium, copper, and carbon fiber.

Clause 18: The electrode assembly of clause 17, wherein the plurality of bristles comprise stainless steel.

Clause 19: The electrode assembly of clause 17, wherein each bristle of the plurality of bristles has a diameter of less than 100 micrometers.

Clause 20: The electrode assembly of clause 17, wherein the plurality of bristles comprise a material selected from the group consisting of stainless steel, titanium, copper, and carbon fiber.

The disclosed technology can be further understood according to the following clauses:

Clause 1: A water disinfection system, comprising: an outer electrode defining an internal cavity extending along a longitudinal axis; a center electrode positioned within the internal cavity and extending along at least a portion of the longitudinal axis, the center electrode comprising a stem and a plurality of bristles extending radially outward from the stem toward the outer electrode; an inlet configured to allow a fluid to enter the internal cavity; an outlet configured to allow the fluid to exit the internal cavity; and a voltage source electrically coupled to the outer electrode and the center electrode and configured to apply a voltage across the outer electrode and the center electrode to generate an electric field within the internal cavity.

Clause 2: The water disinfection system of clause 1, wherein the outer electrode has a cylindrical configuration.

Clause 3: The water disinfection system of clause 2, wherein the center electrode is positioned coaxially within the outer electrode.

Clause 4: The water disinfection system of clause 1, wherein the stem and the plurality of bristles comprise a conductive material selected from the group consisting of stainless steel, carbon fiber, copper, and titanium.

Clause 5: The water disinfection system of clause 4, wherein the conductive material comprises stainless steel.

Clause 6: The water disinfection system of clause 1, wherein the voltage source is configured to apply unipolar pulses across the outer electrode and the center electrode.

Clause 7: The water disinfection system of clause 6, wherein the unipolar pulses have a duty cycle of at least 25%.

Clause 8: The water disinfection system of clause 1, further comprising a non-conductive material disposed in an area between adjacent bristles of at least a portion of the plurality of bristles, the non-conductive material configured to inhibit the flow of water in the area.

Clause 9: The water disinfection system of clause 1, wherein the plurality of bristles have a length that is between 10% and 50% of a diameter of the outer electrode.

Clause 10: The water disinfection system of clause 1, wherein each bristle of the plurality of bristles has a diameter of less than 100 micrometers.

Clause 11: The water disinfection system of clause 1, wherein the voltage is from about 50-80V.

Clause 12: A method of disinfecting a fluid, comprising: flowing the fluid through an internal cavity defined by an outer electrode, wherein a center electrode is positioned within the internal cavity, the center electrode comprising a stem and a plurality of bristles extending radially outward from the stem toward the outer electrode; and applying a voltage across the outer electrode and the center electrode to generate an electric field within the internal cavity.

Clause 13: The method of clause 12, wherein applying the voltage comprises applying unipolar pulses across the outer electrode and the center electrode.

Clause 14: The method of clause 13, wherein the unipolar pulses have a duty cycle of at least 25%.

Clause 15: The method of clause 14, wherein the unipolar pulses have a frequency of at least 500 kHz.

Clause 16: The method of clause 12, wherein the plurality of bristles locally enhance an electric field at tips of the plurality of bristles when the voltage is applied across the outer electrode and the center electrode.

Clause 17: An electrode assembly for a water disinfection system, comprising: a stem extending along a longitudinal axis; and a plurality of electrically conductive bristles extending radially outward from the stem, wherein the plurality of bristles are configured to locally enhance an electric field at tips of the plurality of bristles when a voltage is applied to the stem, and wherein the plurality of bristles comprise a material selected from the group consisting of stainless steel, titanium, copper, and carbon fiber.

Clause 18: The electrode assembly of clause 17, wherein the plurality of bristles comprise stainless steel.

Clause 19: The electrode assembly of clause 17, wherein each bristle of the plurality of bristles has a diameter of less than 100 micrometers.

Clause 20: The electrode assembly of clause 17, wherein the plurality of bristles comprise a material selected from the group consisting of stainless steel, titanium, copper, and carbon fiber.

A number of implementations have been described. Nevertheless, it will be understood that various modifications may be made without departing from the spirit and scope of the disclosure. Accordingly, other implementations are within the scope of the following claims.

1. A water disinfection system, comprising:
an outer electrode defining an internal cavity extending along a longitudinal axis;
a center electrode positioned within the internal cavity and extending along at least a portion of the longitudinal axis, the center electrode comprising a stem and a plurality of bristles extending radially outward from the stem toward the outer electrode;
an inlet configured to allow a fluid to enter the internal cavity;
an outlet configured to allow the fluid to exit the internal cavity; and
a voltage source electrically coupled to the outer electrode and the center electrode and configured to apply a voltage across the outer electrode and the center electrode to generate an electric field within the internal cavity.

2. The water disinfection system of claim 1, wherein the outer electrode has a cylindrical configuration.

3. The water disinfection system of claim 2, wherein the center electrode is positioned coaxially within the outer electrode.

4. The water disinfection system of claim 1, wherein the stem and the plurality of bristles comprise a conductive material selected from the group consisting of stainless steel, carbon fiber, copper, and titanium.

5. The water disinfection system of claim 4, wherein the conductive material comprises stainless steel.

6. The water disinfection system of claim 1, wherein the voltage source is configured to apply unipolar pulses across the outer electrode and the center electrode.

7. The water disinfection system of claim 6, wherein the unipolar pulses have a duty cycle of at least 25%.

8. The water disinfection system of claim 1, further comprising a non-conductive material disposed in an area between adjacent bristles of at least a portion of the plurality of bristles, the non-conductive material configured to inhibit the flow of water in the area.

9. The water disinfection system of claim 1, wherein the plurality of bristles have a length that is between 10% and 50% of a diameter of the outer electrode.

10. The water disinfection system of claim 1, wherein each bristle of the plurality of bristles has a diameter of less than 100 micrometers.

11. The water disinfection system of claim 1, wherein the volage is from about 50-80V.

12. A method of disinfecting a fluid, comprising:
flowing the fluid through an internal cavity defined by an outer electrode, wherein a center electrode is positioned within the internal cavity, the center electrode comprising a stem and a plurality of bristles extending radially outward from the stem toward the outer electrode; and
applying a voltage across the outer electrode and the center electrode to generate an electric field within the internal cavity.

13. The method of claim 12, wherein applying the voltage comprises applying unipolar pulses across the outer electrode and the center electrode.

14. The method of claim 13, wherein the unipolar pulses have a duty cycle of at least 25%.

15. The method of claim 14, wherein the unipolar pulses have a frequency of at least 500 kHz.

16. The method of claim 12, wherein the plurality of bristles locally enhance an electric field at tips of the plurality of bristles when the voltage is applied across the outer electrode and the center electrode.

17. An electrode assembly for a water disinfection system, comprising:
a stem extending along a longitudinal axis; and
a plurality of electrically conductive bristles extending radially outward from the stem,
wherein the plurality of bristles are configured to locally enhance an electric field at tips of the plurality of bristles when a voltage is applied to the stem, and
wherein the plurality of bristles comprise a material selected from the group consisting of stainless steel, titanium, copper, and carbon fiber.

18. The electrode assembly of claim 17, wherein the plurality of bristles comprise stainless steel.

19. The electrode assembly of claim 17, wherein each bristle of the plurality of bristles has a diameter of less than 100 micrometers.

20. The electrode assembly of claim 17, wherein the plurality of bristles comprise a material selected from the group consisting of stainless steel, titanium, copper, and carbon fiber.
